(19) United States
(12) Patent Application Publication
(10) Pub. No.: US 2014/0289598 A1
(43) Pub. Date: Sep. 25, 2014

(54) INTERNET NAVIGATION

(71) Applicant: David Jason Charitos, Redhill Surrey (GB)

(72) Inventor: David Jason Charitos, Redhill Surrey (GB)

(21) Appl. No.: 14/219,724

(22) Filed: Mar. 19, 2014

(30) Foreign Application Priority Data
Mar. 19, 2013 (GB) 1305042.2

(51) Int. Cl. G06F 17/22

(52) U.S. Cl. CPC G06F 17/2235; G06F 17/2247
USPC 715/205

(57) ABSTRACT

The invention provides for Internet navigation methods, systems, link structures and related tools and techniques which can enhance a user experience through at least one of speed of availability, relevance and range of reference information and data, one such method comprising the steps of: receiving a user via a link from an internet accessible source to a target website to be accessed; including within the said link a source-identifier so as to provide for identification of the source; retrieving data from at least one of the source and the target website; responsive to the retrieved data, creating reference data relevant to the target website; and arranging for display of the reference data to a consumer user and wherein the source accessed link can be wrapped with code related to the identity of the source.

With an ever increasing amount of information available on the Internet, it is becoming increasingly important to maintain quality of user-experience by allowing for enhanced navigation, information-gathering and information-display techniques. When pursuing internet search strategies, cross referencing by, for example, banner advertising, pop-ups and pop-unders, or suggestions of further areas of interest, is commonly employed.

The direction of Internet traffic in this known manner can, to a limited extent, serve user experience and also realise monetisation and revenue generation for web site publishers.

However, such techniques for enhanced user experience, and potential revenue generation, are inherently limited insofar as potentially irrelevant advertisements/information are/is still likely to be made available to the user—leading to possibly repeated misdirected navigation through a variety of sites. Also, the information that is made available may not appear in a timely manner and also may be limited in nature and variety. Further, the arrangements for monetisation of the user's internet activity are limited and restricted to a basic advertising revenue-generation model.

The present invention seeks to provide for Internet navigation methods, systems and related tools and techniques embodying a website access procedure having advantages over known such procedures, systems and tools.

In particular, the invention seeks to provide for such methods, systems and related tools and techniques which can enhance user-experience through at least one of speed of availability, and relevance and range of reference information and data.

Within the context of the present invention, beneficial users can comprise various entities such as consumers, i.e. those seeking information from the websites of interest; publishers, i.e. those controlling/publishing/providing source materials websites whose interests are in seeking monetisation from the activities of the consumer; merchants, i.e. those marketers/advertisers seeking to promote their products/services to the consumer; and system users, i.e. those associated with managing or deploying Internet navigation methods, systems and related tools and techniques embodying website-access procedures.

According to one aspect of the present invention, there is provided a website access method comprising the steps of:

receiving a link read from an internet accessible source to a target website to be accessed;
including within the said link a journey-identifier so as to provide for identification of the source and the target;
retrieving data from at least one of the source and the target website;
responsive to the retrieved data, creating reference data relevant to the target website; and
arranging for display of the reference data.

Optionally, the invention can provide for one or more of the steps of:

including within the said link additional performance-enhancing data to assist in the effective collection of reference data (such as for example, country code, post/zip code, age, socio-demographic profile and/or personally identifiable information);
including within the said link the interrupt type: serving to define the inputs available to the user; such as for example, continue with enhanced, continue and option to proceed non-enhanced;
including within the said link the security protocol to properly identify the publisher as the authorised publisher; and
identifying the source and/or target by way of a domain, and/or publisher user, or by way of a URL serving as a pointer thereto.

The invention can prove advantageous in so far as the collection of data from the intended target website, and/or the source location from where the user will be arriving at the target website, allows for quick and efficient gathering of a wide variety of reference data which, through its simultaneous display with the target website can substantially enhance consumer user experience.

In particular, the reference data can be automatically collected, and collated dynamically in real-time simultaneously with the accessing of the target website so as to be ready for display at the same time, or even before, or very shortly after the display of the target website.

The invention can be employed in relation to any form of Internet-enabled source displaying/presenting/linking from and/or to, any one or more, of for example, website, tracking solution, blog, app, article, email or text message.

According to one of various possibilities, the retrieval of data from the source and/or target website can be achieved automatically through keyword indexing & weighting.

According to one of various further possibilities, the retrieval of data from the target website can be achieved automatically through ingesting or analysing comments, from the page source code of a target website, in a format specifically for use with the method. Appropriate examples include voucher and/or discount codes.

Reference data may be retrieved by association with keywords related to a website.

Keywords associated with a website may be determined, discovered, identified and or inferred by spidering, parsing, ingesting or otherwise analysing the content and/or parameters associated with a website during or after loading. A website may also be analysed as above in response to a merchant, publisher or system user request. A website may also be analysed as above by an automated web crawling or spidering system.

Optionally, keyword data may be entered or edited by a system, publisher, and/or merchant user.

Reference data may be retrieved from a database associated with the identity, content and/or above mentioned keywords of a website or linked-to item. Reference data may originate from a merchant and/or a third party. Reference data may also be retrieved from third party data sources associated with the identity or content of a website.

Optionally the reference data may be reviewed by a system user, such reviewed data may be displayed with a higher preference, ranking or reliability.

Also, the display of the reference data and the target website can be provided in any appropriate format whether as a simultaneous frame structure, or by way of a selectable tab structure or by way of interfacing with the device browser. The display format of the reference data and the target website may be determined dynamically by, for example, analysing the consumer user's browsing session, browser version, and/or internet-enabled device capability data.

The reference data can include any one or more of the history of previous websites visited, and/or similar websites such as, but not limited to, competitor websites. However, it should be appreciated that the reference data is in no way limited in this manner and can further comprise any further relevant information such as, for example, related offers, special deals, voucher/discount, availability, trending information etc.

Similar websites can be determined as such by keyword analysis, reference to third party data sources, product category or item matching, and/or system user data entry. Any other method of determining or identifying similar websites may also be employed such as, for example, analysing consumer user internet history, and/or click-through behaviour of other consumer users.

The method of the invention can therefore include further information-retrieval activity related, for example, to news items, the consumer user's previous navigational activity, and the past/current activity of other similar users etc.

In an embodiment, for example, content from third party providers is analysed, indexed or otherwise ingested and stored in a database. In response to a consumer user clicking an enhanced link relevant third party content is selected and/or determined based on matching, scoring or otherwise comparing URLs, keywords, and/or filters between the database content and the enhanced link target website.

The recordal and display of the reference data is advantageously specific to each consumer user, or each consumer user's internet-enabled device.

Reference data may also be selected and displayed based on the activity of consumer users. Click-through rates & activity may be stored for consumer users with reference to the source and target of the link clicked. A probability tree related to the interest of the consumer user can be built. Such a tree may also be determined and/or modified by other consumer activity such as, for example, other recent activity, conversions, and/or other engagement.

The method further allows for the publisher user to enable the automatic inclusion of the enhanced link by default, upon loading of their source document. Optionally such feature can however be selectively disabled either by the consumer user or publisher user.

According to another aspect of the invention there is provided a website access method comprising the steps of: selecting by way of a web browser function a target website by way of a URL to the target website;

incorporating a toolbar function into the browser wherein the toolbar function offers a selection of functionality relating to reference data associated with the target website;
retrieving reference data relevant to the target website; and
arranging for display of the reference data to a consumer user responsive to selection by way of the toolbar function.

The methods outlined above embodying the invention can, as a further advantage, include a step of switching the focus of the said reference data from the said target website to a further target website and in response to user input

According to another aspect of the present invention, there is provided an internet navigation system comprising:

a receiver for reading a link from an internet accessible source to a target website to be accessed;
an identifier for including with the said link a journey identifier so as to provide for identification of the source and the target website;
a data capture element for retrieving data from at least one of the source and the target website;
a reference data collator for creating reference data relevant to the target website and responsive to the retrieved data; and
a display for the display of the reference data.

In particular, a data capture element and reference data collator can be arranged to operate dynamically in real-time simultaneously with the accessing of the target website so as to be ready for display at the same time, or even before, or very shortly after display of the target website.

The system can be employed in relation to any form of Internet-enabled source displaying/presenting/linking from and/or to any one or more or more of, for example, a website, blog, article, email, application or text message.

Further, the identifier can be arranged to provide code that is combined with, so as to enhance, the said link. In this manner, the method provides for the wrapping of code around the link and as will be appreciated the link comprises an exit link from the source.

The identifier of the system can further be arranged to identify links within the source that point externally to the source's domain, website, blog or article, and enhancing each such link with the journey-identifier. Advantageously, the source identifier can automatically be added in this manner as the user load the source.

The system can also be arranged to provide for the recordal and display of the target website for subsequent-user selection in a manner that, particularly through use of the enhanced link, can also recall the navigation path from the source.

The methods and system of the present invention can further include the step of, a controller for, switching the focus of the said reference data from the target website to a further, different, target website, and generally responsive to a user input.

When employing this aspect of the invention, a user is not just able to view the reference data for a particular website (e.g. the initial target) but they are able to switch the target/focus to an alternative website so that they may see all of the reference data for that website instead.

Such changes in “focus” can form an important part of the invention subsequent to the provision of the journey-identifier, and, as appropriate, post enhanced-link formation, since it can enable a user to begin a series of new journeys from within the method/system of the present invention.

According to still a further aspect of the invention there is provided a dynamic publisher-user internet navigation tool arranged, in real-time, to identify an exit link at an internet accessible source, the exit link linking to a target website and the tool further arranged to add a journey-identifier to the exit link identifying a journey to the target website.

According to yet a further aspect of the invention, there can be provided a link structure of an exit link at an internet accessible source, allowing navigation to a target website, wherein the link includes, or is associated with, a journey-identifier of the source so that both the source and target can be readily identified at the time of link selection, for retrieving data from at least one of the source and target to create reference data for display preferably along with the target web site.

Advantageously, the said identifier can comprise code which is preferably wrapped around the said exit link.

Each of a plurality of external links at the source can include said identifier and deployment of the identifier can be enabled and disabled as required.

An “enhanced link”, such as that forming an important part of some embodiments of the present invention, can therefore in one particular arrangement comprise all exit links on a publisher's source document, e.g. website, blog, email, app, text or indeed any other internet accessible publishing medium.

The Consumer user can be given control to switch this method off or on, via the publisher's source or via the link itself.

The enhanced link code can contain the destination link that is being wrapped, and may also contain any one or more of:

the initial user settings such as, for example, country code, post/zip code, age, socio-demographic profile, purchasing type where available to the publisher;
the interrupt type: such as defining the inputs available to the user: continue with enhanced, continue and option to go non enhanced; and
the security protocol to properly identify the publisher as the authorised publisher (for server side implementation).

A consumer user may undertake a journey between two internet accessible sources by clicking on an enhanced link.

A user may be provided with information relating to the enhanced link system when a link is clicked. Such information may include for example, terms and conditions agreements, cookie agreements, help notifications, update notifications, or any other related information. The user may optionally be prompted to log in or otherwise associate the current machine or session with an existing account, machine or session.

Further, the invention proves advantageous to the customer user by providing a user-journey history collated by journey type (e.g. loans) or by journey source and/or destination (e.g. particular website). Also, addition commercial information such as similar website link suggestions related to the history can be readily accessed.

As a further enhancement, the invention can also make available to the user and one or more of:

reviews and/or ratings on the original destination site and similar websites;
the opportunity to provide a review or a rating on sites which have been visited;
other promotional offers which are matched to meet the user settings;
tools and tips to further enhance the user's use of the exit link, such as topic editorial, and definitions etc.
private notes to retain comments on websites visited which are only available to the user; and
passwords, so that the user may record individual passwords for each website.

In an embodiment of the present invention a consumer user can be provided with an interface which enables notes to be added and/or edited by the user relevant to the internet accessible source being accessed, and/or to the journey being undertaken. The notes may be stored in a database and displayed to the user on subsequent visits to the internet accessible source and/or on repeat or similar journeys. The notes are not visible to other consumer users.

One further aspect of the present invention therefore relates to a method of monetized internet navigation whereby repeat traffic to a referred website is directed so as to retain reference to the publisher from which the referred consumer originated.

According to another aspect of the present invention, a consumer user may access an administrative website without clicking an enhanced link. The administrative website may provide the user with, for example, a history of visited internet-accessible recourses, visited sources, past journeys undertaken, similar websites visited, notes made, and/ vouchers used. The administrative website may further provide the consumer user with suggestions of further resources and/or reference data relevant to the consumer user's previous usage history. The administrative website may also provide the consumer user with administrative functions such as, for example, editing saved passwords, notes, journey and website histories, etc.

As will therefore be appreciated, the present invention provides a means for producing reference data, which can be in the form of a user specific website, produced dynamically in real-time and on an intelligent basis having regard to the customer user's past and present Internet activity.

As will therefore be appreciated, the invention can provide for a Link-enhancement tool that can comprise code that a publisher actually loads into a source website and interacts with the page, whereas the main system can processes the changed link in a way which interrupts and enhances the journey.

The invention is described further hereinafter, by way of example only, with reference to the accompanying drawings in which:

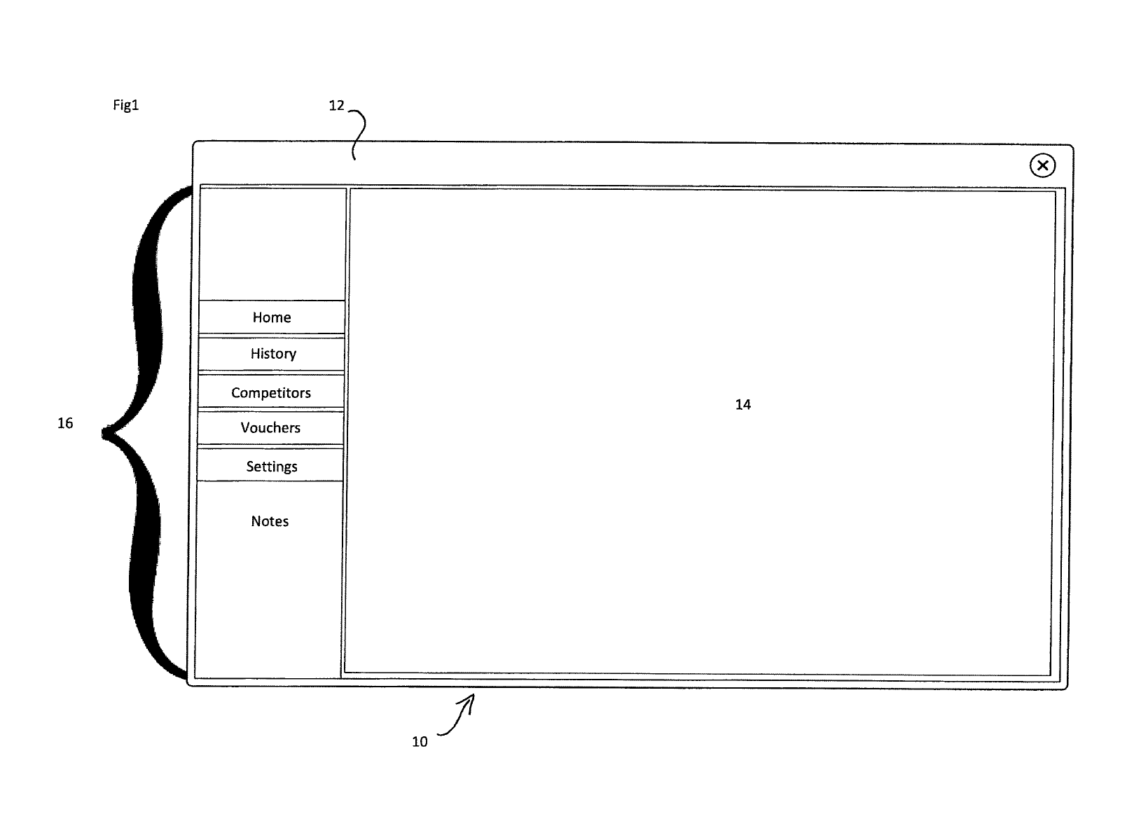

FIG. 1 is an illustration of a front-end display of a system according to an embodiment of the present invention and employing a frame display;

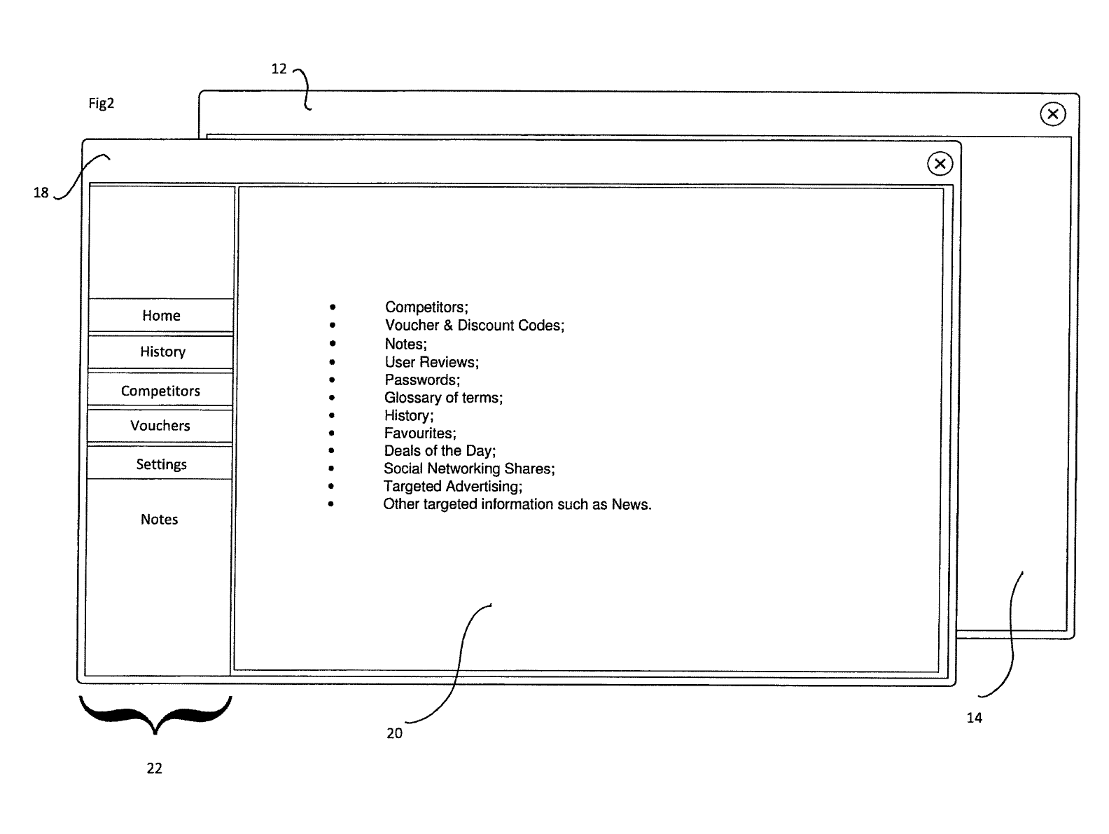

FIG. 2 is an illustration of a front-end display of a system embodying the present invention and employing a tab display:

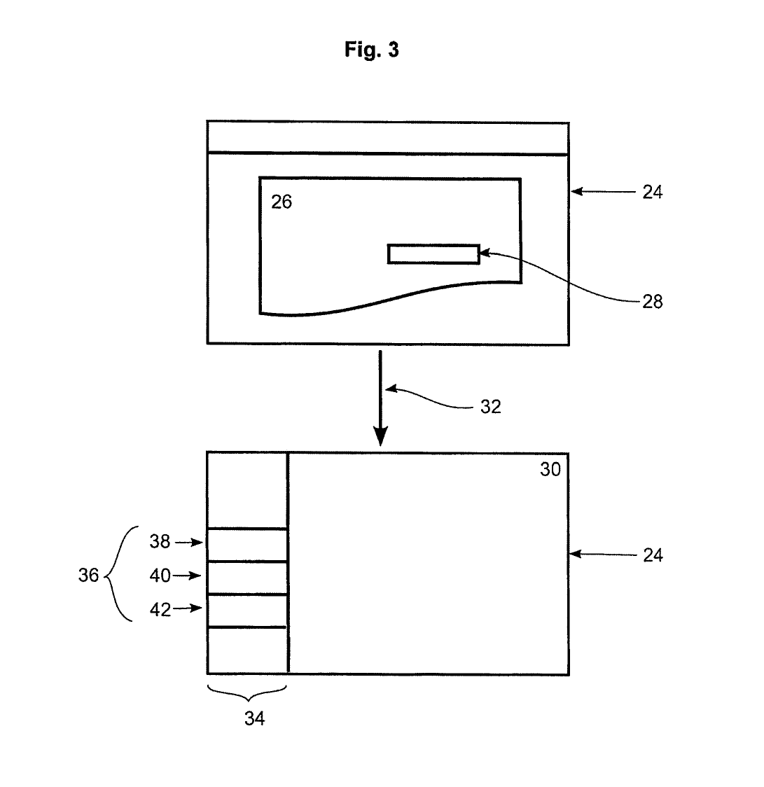

FIG. 3 is a schematic flow diagram illustrating website accessing according to an embodiment of the present invention;

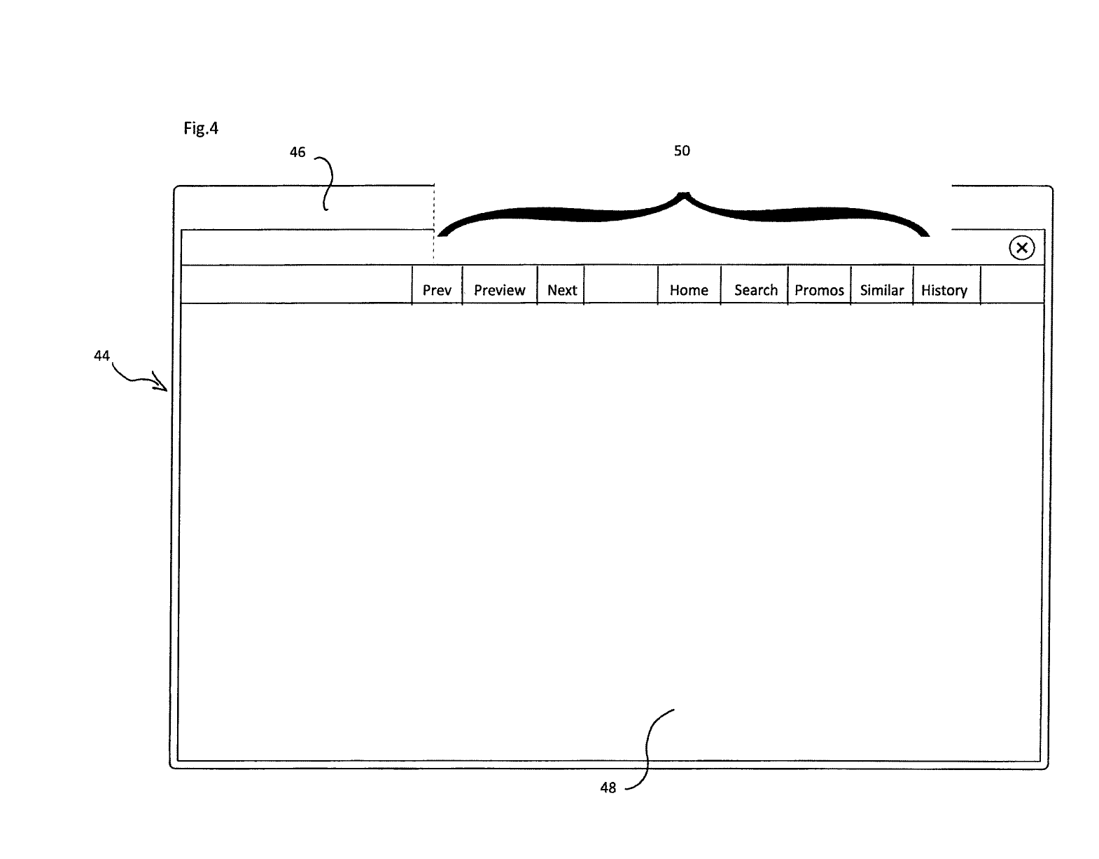

FIG. 4 is an illustration of another example of a front-end display of a system according to another embodiment of the invention;

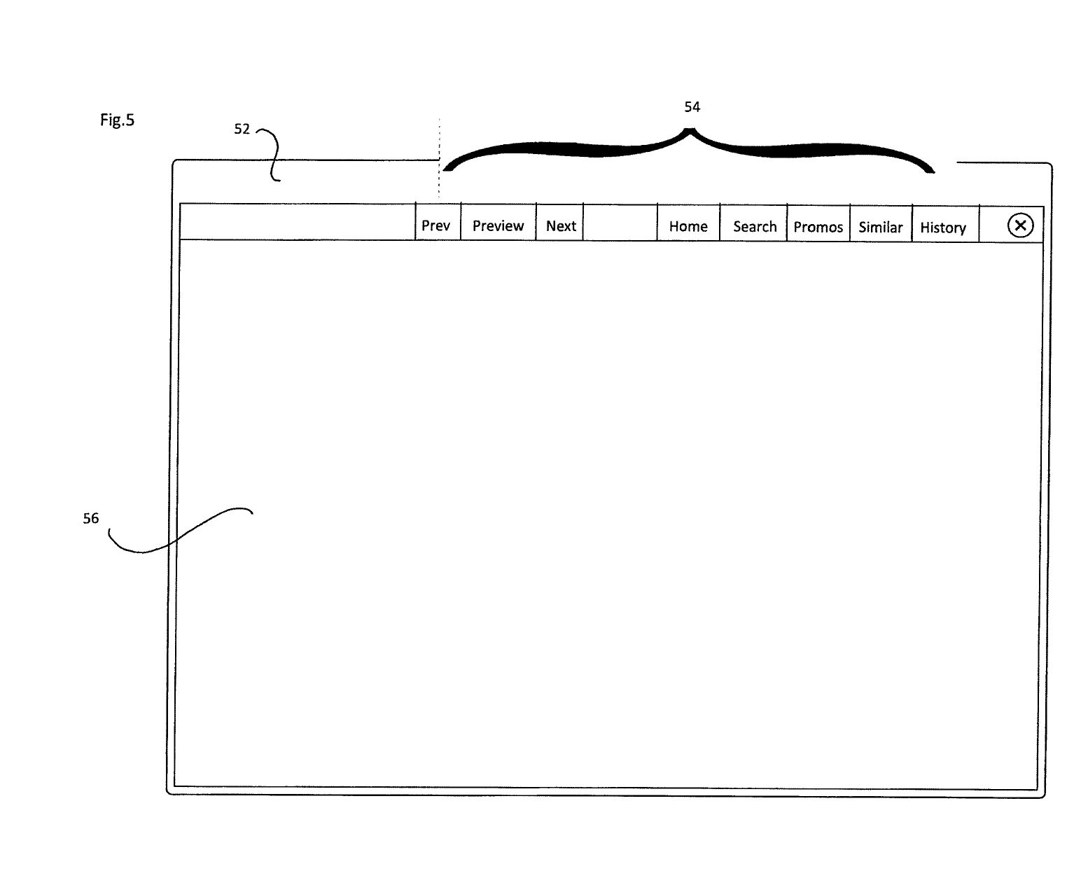

FIG. 5 is a variant of the further example of FIG. 4;

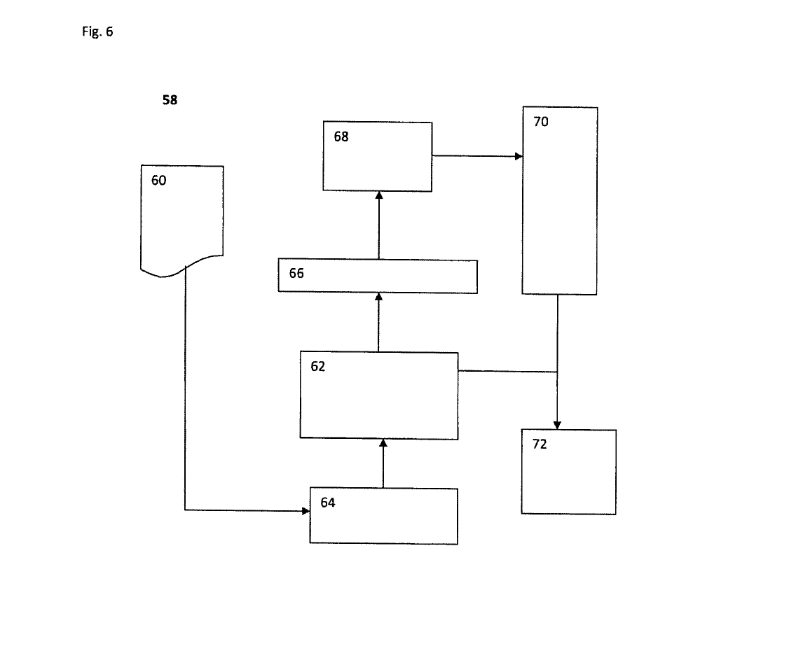

FIG. 6 is a schematic view of an interne navigation system embodying the present invention;

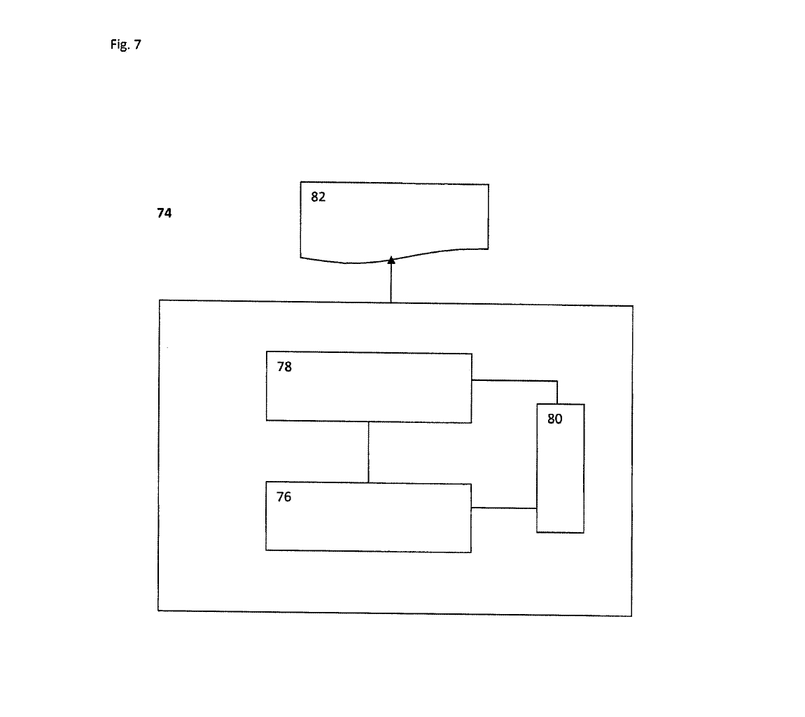

FIG. 7 is a schematic view of a dynamic publisher-user tool according to another embodiment of the invention; and

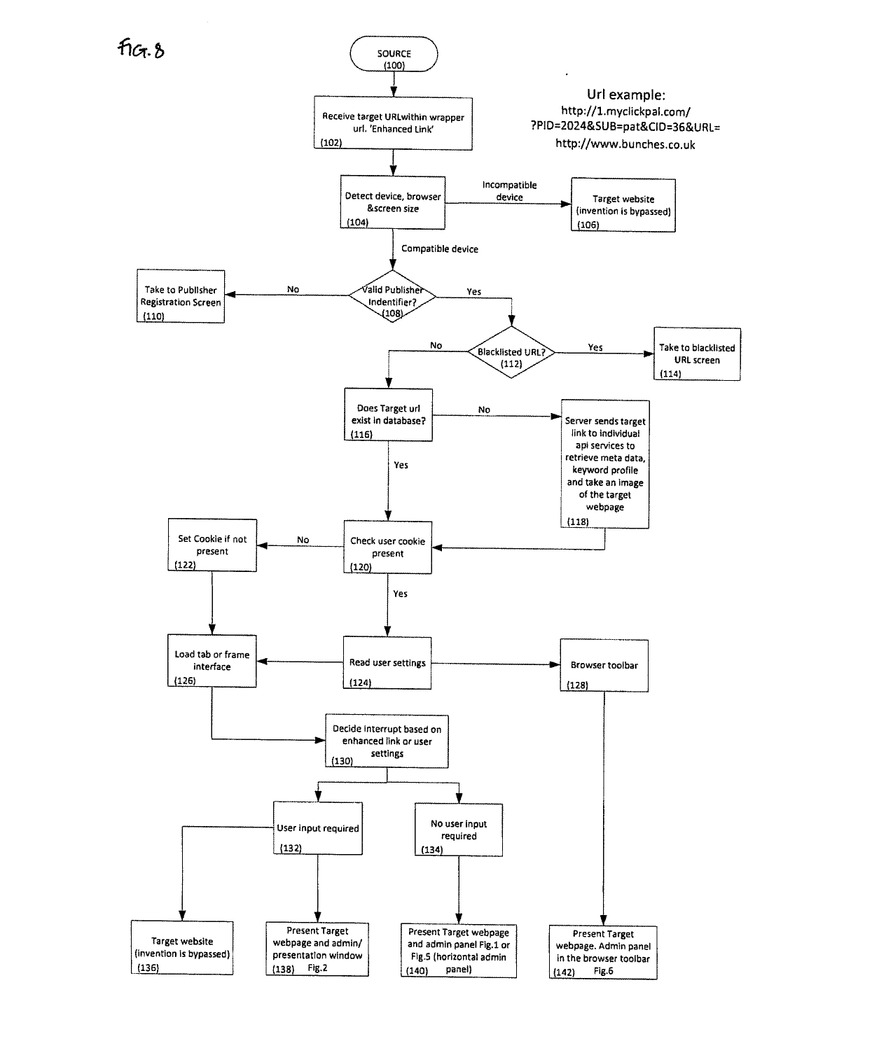

FIG. 8 is a flow diagram of further details of the method according to the present invention;

Turning to FIG. 1, there is provided an illustration of a screen display 10 of an Internet enabled device and having been employed in navigation sessions according to the present invention.

The screen display 10 represents a browser window 12 within which window appears two sections 14, 16, with section 14 displaying in a frame format the target website. The user is able to navigate around the target website as normal within, for example, an iframe from within the site of an administration interface such as provided by the second section 16 in the form of an administration panel.

In an advantageously dynamic real-time manner therefore, the consumer user can be presented with a wide variety of information directly associated with the target website such as, for example: similar web sites for example belonging to competitors; voucher and discount codes; reviews; passwords; glossary of terms; Wiki; news; and notes; As a further option, a wide variety of information generally associated with the consumer user settings, actions and various journeys made by the consumer user such as, for example: history; favorites; offers and “Deals of the Day”; social networking shares; and targeted advertising.

There can further be provided a Tab version whereby the target website is opened in a different Tab or window, if for technical or performance reasons it is not possible or not desirable to open the target website in a, for example, iframe.

In this version the administration website sits in the background waiting for the consumer user to either close down the Tab/window containing the target website or to actively select the tab/window containing the administration interface. FIG. 2 demonstrates an example page which the user could be presented with when they return to the administration interface.

This Tab version, for illustrative purposes, shows the target web page 14 underlying the administrative web site, in this example displayed in a browser window 18 and including a section 20 displaying a dynamically created administration webpage which may include a variety of information to encourage the visitor to take further journeys for example, to satisfy their current needs and curiosities. These options may as before include, for example: similar websites such as those of likely competitors; voucher and discount codes; user reviews; passwords; glossary of terms; Wiki; notes; history; favorites; deals of the day; social networking shares; targeted advertising; and/or other targeted information such as News.

An admin panel 22, which can represent a dynamic variant of the admin panel 16 of FIG. 1, remains presented to the user along with the administration webpage 20.

As a further option the illustrated embodiment can optionally include the ability to create notes regarding the current journey and/or any journey a user has undertaken via the invention.

In an embodiment a browser plug-in or other browser interface version may be provided whereby the display of the administration console is controlled by the browser. Furthermore, during such Internet activity, the consumer user has been directed to, and selected, these websites by way of the “enhanced links” of the present invention found at source locations, such as, for example, search engines, third-party websites, blogs, e-mails etc. The publishers of such sources as previously enabled the “enhanced link” functionality such that reading of the link not only directed the consumer user to the target website 14 but also created reference data as illustrated by way of a user-specific administrator website illustrated at 16, 20, 22 that can be displayed alongside the display of the target website(s). Through the retrieval of data from both the source and the target website, and, if required, from other locations such as, for example, news items, voucher codes, reviews, etc., records of the consumer uses past activity, the activity of similar users etc., the reference data 16, 20, 22 can comprise a wide variety of information serving to enhance the consumer users interaction with the target website, whether assisting directly such interaction, or suggesting tightly attractive alternative journeys that the Consumer user may wish to take.

Through use of the journey-identifier within the enhanced links, any such further Internet activity via the browser window of the invention can readily be tracked to the advantage of the publisher of the source document through ongoing monetisation of the increased focussed Internet activity of the consumer user.

According to an embodiment, the initial procedure for accessing a target website and populating a user-specific reference data field/website is now described further with reference to FIG. 3.

Here there is illustrated a screen 24 of a consumer users Internet-enabled device which is displaying, for example, promotional article 26 on a particular subject of interest and which includes an external link 28 to a target website 30, at least a section of which is also concerned with that subject. The external link 28 is enabled as an “enhanced link” according to an embodiment of the invention so as to be code-wrapped to include an identifier of the publisher of the promotional article 26.

Upon the consumer user clicking 32 on the enhanced link 28, the user's device accesses the target website 30. At this time, in an advantageously intelligent and dynamic manner, the enhanced link 28 allows for the method/system of the present invention to identify both the source article 26 and the target website 30 and pull or retrieve data therefrom, so as to create and populate a reference website 34 of an administrator employing the method and/or system of the present invention. As indicated previously with reference to FIG. 1 and FIG. 2, the display 24 of the consumer user's Internet-enabled device displays not only the target website 30, but also within its own user-specific website 34 the dynamically obtained reference data 34 which can be readily accessed by the consumer user to enhance their interaction with the target website 30. As noted previously, such reference data can be collected from a wide variety of further sources including news items, records of past Internet activity, current trending activity for the subject area concerned etc. All such information can therefore be gathered automatically in real-time (or as close too as practicable) so as to offer indexed displays to the consumer user of, for example, similar websites such as those of competitors 38, history 40, vouchers and discount 42 etc.

The consumer user can therefore select the category of reference data that they believe might be most relevant to their current journey or interaction with the target website 30.

As a further alternative, it should be appreciated that a user can employ a toolbar such as that with the “dynamic” functionality as discussed herein and which can be referred to as a dynamic toolbar. The adoption of such a toolbar within, for example, a web browser can apply such functionality to a URL input into the browser and which is associated with a target web page. Then, if a user has installed the browser dynamic toolbar and they use a link that is not a wrapped-enhanced link as arising in some aspects of the invention, the user can be presented with the target website. While the user's browser is loading the target website, the database of reference data of the invention can be checked to asses if the target URL is already found therein. A “new” target URL, i.e. one that is not already in the database can be added for future reference. This example of the invention can display alerts, such as promotions or discounts for the target website of interest, and this display can occur in either the toolbar or in the browser window and responsive to user settings. This aspect of the invention is arranged such that if a user clicks on one of the toolbar icons offering the selection of functionality provided according to the invention, such as “similar sites”, this can then display similar sites to the site the user was interested in. Although there may then be no actual interrupt to the consumer journey, an “enhanced link” can still be created.

Thus, an aspect of the invention can employ a dynamic toolbar installation, such that a user that has installed such a toolbar of the invention into their browser will be able to access the database reference data and systems of the invention on any URL that appears in the browsers address bar. In this manner, no initial code-wrapping need occur and a link does not have to be “enhanced”. Any such enhancement arises from the consumer journey to/from different web pages, websites and information resources in general. The invention tool will only display information associated with the URL in the address bar responsive to user-request by clicking on one of the toolbar icons, or by way of an activated “alerts” button in the user settings. In advance of an icon being clicked the invention will search its database for information relating to the web address that is in the browsers address bar. The web site that is currently being viewed within the browser window will be replaced by the information supplied by the invention and relating to the users URL in the browser address bar. The current URL can be recorded by way of cookie so that the user may return to the site by clicking on the preview/website button.

Within the context of the present invention, and the above-mentioned embodiment in particular, it should be appreciated that reference to a browser, toolbar and browser toolbar, and related functionality, includes reference to related applications and interfaces such as, but not limited to, a Browser Add-On and/or Mobile App.

In illustration of further variants of the front-end display of target web page and admin panel, according to embodiments of the invention, reference is made to FIGS. 4 and 5 wherein a horizontal configuration of the administration panel is illustrated, with further optional functionality included.

Turning first to FIG. 4, the front end display 44 of an internet-enabled device is illustrated and shows a browser window 46, target webpage 48 and admin panel 50. Functionality represented by this admin panel 50 includes a preview option for returning to the preview of the last website that had been viewed. This can either comprise the target website or any further website that had been previewed. In the example, next/previous navigational options also exist for ease of navigation to alternative/similar sites to the target website and as suggested according to an aspect of the invention. In the example of FIG. 4, the admin panel 50 is provided within the target website 48 as illustrated. Of course, the admin panel can be provided within the browser toolbar and such further variant is illustrated in FIG. 5. Here a browser 52 has its toolbar encompassing the admin panel 54 and so outside of the target web page 56. Again similar preview and navigational functionality to that of FIG. 4 is provided within the admin panel 54.

With regard to the FIG. 1 and FIG. 4 embodiments, the target web page 14, 48 may have a transparent or semi-transparent layer sitting over the top of the target website. The user would still be able to scroll up and down on the target website. When the user clicks on the layer the target website opens in a new window/browser tab.

The employment of such a transparent or semi-transparent overlay can prove advantageous in protecting a consumer user from opening in iframe format a website that the administrator identifies as “unsafe”, since such use can then be directed to a new tab to open that website.

Turning now to further details of just one illustrative example the dynamic creation of reference data and the reference web site, this can proceed in a manner such that the enhanced link url is analysed. The target url is extracted using SQL select statement which looks for a specific parameter such as URL= and extracts all the information after URL=. The database of the invention is checked for a match to this target url, this is again done using SQL select statements. If there is a match, the stored information related to the target url is retrieved and processed. If there is no match the invention collects information from the target source page to build a snapshot of the target website. This snapshot is cross-referenced (using SQL select statements) with the database of the invention to access the stored information related to the target url.

The User cookie is then checked for any previously saved settings and identifiers in the enhanced link are checked and the resulting display of the stored information is either in the presentation area (see 20 of FIG. 2) or not accessed until the user clicks on control in the admin panel 22.

The stored information can have been supplied by any one or more of users, third party web services or the inventors own input and is all linked by the target url.

Within the front-end illustrations of embodiments of the invention, in particular FIGS. 1, 2, 4 and 5, various options arise for tab-functions and presentations detail and for details of these are discussed below.

A “Promo” feature can display promotions so that a user can see the promotions for the target url or the current site being viewed/focused on at the time this page is visited. Also lists promotions and discounts for sites similar to the target url/viewed/focused site.

A “Similar Sites” feature can display sites that are similar or competitors. The user can see a list of Similar sites and competitor sites to the target url or the current site being viewed/focused on at the time this page is visited.

A “History” feature can show user history and which can display the sites that the user has clicked on and visited whilst using the invention. The user has the ability to delete these sites.

A “Search” function can provide for a search page allowing a user to search the inventions database to find sites that they may wish to visit. It also displays search engine results such as those used in Google Search.

A “Product Preview” function allows for scroll-thru previews of websites displaying a particular product. The user can select a product, the database then prepares a list of websites with the product listed. The user is then able to press the Next Preview button to take themselves from site to site offering the product.

A “Product Search” feature can be employed for product look up. Here a user can enter a product description. The database then returns a list of possible matches. The user then selects the product matches which match their requirements, the database then returns a result set of websites offering the product(s) with prices and other information for comparison.

A “DueDil” feature allows for Due Diligence/accounts reviews to be conducted against the site in focus/the target and when the user enters the duedil screen the system can use an API to retrieve accounting and other information from one or more due diligence sources based upon the website in focus. Alternatively the consumer enters further information such as company name and or company number to facilitate further retrieval actions.

A “Sales Promotions” feature allows for a merchant to upload Sales messages to users. The merchant may use the MyClickPal folder on their webserver to present a sales message to visitors in preview mode. The content of the file is presented as a Sales Alert

A “Daily Deals” feature can be employed to provide alerts with a new daily deal and providing for a page displaying a deal or discount for use that day.

A “Buzz” feature can interface to social media such as Twitter and Facebook. Using API's to Twitter and Facebook the System interrogates these systems for posts/pages and tweets regarding the website in focus and presents them on the Buzz page.

A “Reviews” feature provides for the input of user reviews. API's to 3rd party review sites can be used to retrieve reviews for the site in focus and presents them on the Review page. A further enhancement allows users of the invention to add reviews and read reviews by other users of the invention.

A “notes” feature allows for a user to keep their own notes. The user is able to assign a note to a particular webpage. This note may be added or retrieved in the Notes Page.

A “Contact Us” feature can be arranged to pull-in the contact details of the site automatically.

The system can spider the website and retrieves likely contact information. This information is then presented in the contact us page.

A “Classified” feature can be provided to show second hand products for sale. When a user is using the product preview functionality, second hand items matching the product description can be listed in the classified page. The classified page is created using an API to multiple classified providers and retrieving lists of smalls ads offering the matching services.

A “Trust” feature can pull-together all of the duedill, review & buzz info plus editors comment. In particular it can pull together all of the duedill, review & buzz info plus editors comment, to give an overall trust score.

A “jobs” feature can be employed to display jobs for the site in focus. Using API's into major job sites, the system presents the user with a comprehensive list of jobs advertised by the organisation behind the site in focus. Further, a “jobs preview” feature allows for scrolling through employer/job websites offering the same or similar job. The user selects a job title and various parameters, the database then prepares a list of websites with the job listed. The user is then able to press the Next Preview button to take themselves from site to site offering matching jobs.

A “favorites” feature will allow a user to save websites in focus as a “Favorite”. By visiting the favorite's page at a later stage the use may click on and return to the favored website. A “login” feature can assist the creating of an account related to the invention so that all stored information can be shared between devices. Further, it can be employed to create and account into which all history, preferences and favorites may be stored.

A “marketing” feature can be employed to show affiliate details, pr details etc. This can relate to a specialised use of the invention. For a subscription, the invention can be used to pull together a specialist combination of information. The marketing subscription allows the user to gain insight into where the site is being advertised, what PR stories have been released plus information regarding any agencies appointed to manage the account.

A “The editor” feature allows the invention to provide comment on a particular product or website. This feature allows for the invention to make particular and individual comment regarding a website and it's content.

A “people” feature can be related to (linked-in) profiles of people currently employed or associated with an organisation. A People Page allows a user to see the public profiles of all of the LinkedIn (or similar) users associated with that website or the organisation behind it. The invention can achieve this through the use of an API to retrieve details from the 3rd party provider and then present them onto the people page.

A “wiki” feature can lead to the provision of information about/relating to the site held on Wiki type websites. Using search functionality within the invention, it is possible to locate information regarding the website or product or content which the user is looking at and display a list of potential links for review.

A “glossary” feature can offer a glossary of terms. If the site has a glossary of terms, the invention can retrieve the information and present it in the Glossary Page.

A “news” feature can provide for retrieval/display of any news articles relating to the site. Using an API into 3rd party news websites, the invention can present news relating to the website in focus.

It should however be appreciated that the above list is non-exhaustive and simply serves to illustrate the wide variety of functionality that can be achieved by the invention with regard to the, as required, highly focused nature of reference data retrieved (displayed in real time or at least near real time).

As an illustration of one example of an internet navigation system embodying the invention, reference is now made to FIG. 6 which is a schematic representation of such a system 58 arranged to-receive a user-interaction via a link from an internet accessible source 60 which includes a link to a target website (not shown). The system includes a processing function 62 operatively communicating with a reader 64, to extract the journey identifier.

For a link-read from the source 60, a journey identifier as described elsewhere herein is extracted from the link by means of an identification processor 66 and which serves to identify the source and the target website. A data capture element 68 is also included for retrieving data from at least one of the target or the source and such retrieved data can be collated by a data collector 70 for creating reference data relevant to the target website, which reference data can then be displayed on a display 72.

Another aspect of the invention comprises a dynamic publisher-user internet navigation tool and an example is schematically illustrated in FIG. 7.

Here, the tool 74 is arranged to receive a link from an internet accessible source 82 which includes a link (not shown), and referred to herein as an exit link, serving to point towards a target website (not shown). To achieve the functionality of the invention, the tool 74 includes a processor function 76 in operative communication with an identifier 78 and a code-enhancer 80.

The identifier 78 is arranged to include with the link a journey-identifier as described elsewhere herein and which serves to provide for identification of the source and target website. In the illustrated example, the identifier interacts with the code-enhancer 80 to enhance the link in the manner described elsewhere herein and so as to provide the journey identification. Of course it will be appreciated that the tool illustrated in FIG. 7 can be employed with, or within, a system embodying the invention and as described herein.

Further details of a system/method embodying the present mention are found with reference to FIG. 8 which also illustrates further options relating to an auto registration procedure for the consumer user.

In considering the detailed example provided by FIG. 8 of a process embodying the invention and as illustrated it should be appreciated that unless, stated otherwise, all calls to the database of the invention and relating to the construction/collection of the reference data are made via an Application Programming Interface (API), and wherein if database tables require checking and/or searching, this is done using SQL select statements.

The process starts with reference to an internet accessible source 100 which can be an email, website or any document that contains an internet link that has been enhanced and wrapped with according to an embodiment of the invention.

Once a click has been made 102 on the source, the enhanced link directs the user to an administration server via for example the myclickpal.com domain reference in the enhanced link illustrated, i.e.

http://1.myclickpal.com/?PID=2024&SUB=pat&CID=36&URL=http://www.bunches.co.uk

An enhanced link is made up of the journey-identifier:

http://1.myclickpal.com/?PID=2024&SUB=pat&CID=36&URL=

And the target link:

http://www.bunches.co.uk

The server records 104 the user agent of the user device. A user agent provides details of the browser and device being used by the user. By looking at the device type it can also prove possible to determine screen size. The user agent is checked against a list of the user agents that the invention is compatible with. If the response is false, and therefore the device is incompatible with the invention then the user is sent directly to the target website and the invention is bypassed 106. If the response is true, and so the device is compatible, the user is sent to a predefined website of the invention which is configured to display correctly on the device.

For example if using the link above the user finds themselves on the www.bunches.co.uk website without a MyClickPal interface then their User Agent is not compatible with the invention and they should attempt the link with an alternative browser/device

As noted when a device is incompatible the user is sent directly 106 to the target url and the invention no longer has the opportunity of enhancing the link.

A publisher identifier can be provided in the enhanced link as a PID=parameter. This is checked in the database 108 to confirm that the publisher has registered for use of the invention and has accepted the terms and conditions related to the invention, and has a status of active.

If the publisher does not pass the checks 108 then the user is redirected 110 to a publisher registration page. All publishers can be required to register before they can use the invention.

If the checks are passed, the target url is next checked against a table of blacklisted urls 112. If there is a match, then the user is taken to a black-listed url screen 114. The blacklist urls table is populated manually with any urls that the administrators wish to list.

If not blacklisted, the process proceeds at 116 to employ a SQL select query to extract the target url from the URL=parameter. The inventions database is checked to see if the target url already exists. Each new target url gets added to the database so the process can avoid having to take the steps 118 every time a user clicks on the same source.

At 118, the invention then communicates with a .NET web browser control via a DLL driver to establish the effective url of the target url. The effective url is the final page reached after any third-party-redirects on the target url are complete. This can be found by recording the url when the frame load is complete and then putting the recorded url through the same process. Once the url put into the effective url process is the same as the one that is recorded as frame load completes then the process can accept that the effective url has been found.

A third party service can then be interrogated using the effective url and the returned response provides a list of keywords that are associated with the target url. This keyword profile is saved in the database and associated using an ID with the already saved target url. Keyword profiles are later manually checked. The process can acquire the meta keyword and description from the source information of the target website. This can be done either via a third party API or directly using the invention via the .NET web browser control.

The process can employ either a DLL driver using a .NET web browser control or a third party API to take snapshot image of the effective url web page. All the information gathered in this process is then saved and associated with the target url using an ID.

Next, at 120, and using Laravel Cookie Class, the process checks to see whether the user already has a cookie from the invention saved within the devices' web browser software. If not present, then at 122 using Laravel Cookie Class, a cookie is created and then encrypted. The browser is then requested to save the cookie onto the users device. If the user's web browser doesn't allow cookies then there is no need to place one, although this is not preferred.

If at 120 it was determined that a cookie is present, then at 124 the invention checks the cookie for an encrypted user ID. The userID is decrypted and the database is then checked for any user settings such as: particular buttons displayed on the control bar; whether the user has installed the toolbar; or whether the user prefers to view the invention in the tab or frame interface.

Depending on the front-end configuration then at 126 either the tab interface such as of FIG. 2 or the frame interface of FIG. 1 or horizontal frame interface of FIG. 4 is loaded in the user's browser.

At 128 and if the browser toolbar FIG. 5 is already part of the user's browser as they will have installed it on a previous occasion, then it will also be present whenever the user uses the browser they installed it on.

If the loading at 126 is required, then next at 130 and with the enhanced link containing CID=parameters which references a page and/or interrupt setting that is configured in the invention's database, it is specified which landing page is to be used and whether an interrupt box is displayed requiring user input.

If it is determined that user input 132 is required, an interrupt box is displayed. The user can then interact with this message box and can either accept or not accept that their journey will be enhanced.

If it is determined that 134 user input is required, the process moves directly to step 140 described further hereinafter.

If the user does not want their journey enhanced then they can bypass 136 the functionality of the invention and go to the target url as if the target url had never been wrapped with the journey-identifier. If not, then there are various alternatives for the presentation of the target webpage according to the invention.

For example at 138 the target url is presented in a new tab or window with the users browser such as in FIG. 2. The initial tab sits behind the new tab which is showing the target url web page. This initial tab displays the admin panel 22 of the invention and the presentation area 20 as noted. The presentation area 20 is populated with information that is associated with the target url ID and was collected in step 118. If the user's browser does not have tab functionality then new windows are opened instead of a new tab.

At 140, and referring to FIGS. 1 and 4., the target url is presented in the target webpage area 14, 48 and the admin panel 16, 50 of the invention can sit within this tab.

As a further example, at 142, and as illustrated in FIG. 5 the target url is presented in the target webpage area 56 and an admin panel 54 sits within the users browser 52.

As noted above, there is an alternative of the invention that can employ toolbar with “dynamic” functionality as discussed herein and which can be referred to as a dynamic toolbar. The adoption of such a toolbar within, for example, a web browser can apply such functionality to a URL input into the browser and which is associated with a target web page. Then, if a user has installed the browser dynamic toolbar and they use a URL that is not enhanced with the journey-identifier as arising in some aspects of the invention, the user can be presented with the target website. While the user's browser is loading the target website, the database of reference data of the invention can be checked to asses if the target URL is already found therein. A “new” target URL, i.e. one that is not already in the database can be added for future reference and so as to avoid having to take steps such as 118 each time a user clicks on the same source. With reference to FIG. 8 it should be appreciated that this alternative embodiment of the invention can continue on the same data-retrieval path as illustrated in FIG. 8 from step 116 onwards, and the profiling of step 118 can occur as the website of interest is loading into the “dynamic” browser.

Thus, the aspect of the invention employing a dynamic toolbar installation, and wherein a user can have installed such a toolbar into their browser will be able to access the database reference data and systems of the invention on any URL that appears in the browsers address bar. In this manner, no insertion of the journey-identifier is needed and a link does not have to be “enhanced”. Any such enhancement arises from the consumer journey to/from different web pages, websites and information resources in general. As noted with further reference to FIG. 8, as the user's browser is loading the target website the steps from 116 onwards can continue.

All user settings, notes and history can be set to display per cookie or per user. The cookie may be a first party cookie, a third party cookie, a session cookie, and/or a persistent cookie.

It should be noted that the invention is principally designed for use without collecting any personally identifiable information from the consumer user.

However, where recorded per user, the consumer user may associate each cookie on each device to one user account requiring an email address, thereby pulling together the history from all devices into a single account. This also protects the consumer user's settings, history and notes from becoming irretrievable if the user clears their cookies or other tracking method.

The consumer user may register a tracking ID on each device and this information can also be added to the account by using a primary device such as a PC. The set-up for each device is permanent unless the tracking information is deleted from the device.

The method and system of the present invention seeks to provide for a significantly enhanced user experience whilst also increasing the revenue for a publisher without any noteworthy cost. This can advantageously provide the method as a significant new revenue model.

The invention can prove advantageous to the customer user by uniquely combining one or more of the following benefits into one interface:

easy access to journey history stored in a hierarchical manner overcomes the need or likelihood for the user to return back to locations they have already been;
competitor information makes the decision process easier and quicker;
creating private notes makes the retention of personal thoughts, pricing info, product codes, phone conversations etc easy and convenient;
getting to the check-out with a discount code ready to go is very satisfying not to mention rewarding;
having the supplier reviews right there when the consumer needs them, giving peace of mind, allowing for quicker & more confident transactions;
learning from the past and anticipating the future needs of the consumer is a rewarding aspect of the invention, since when it operates successfully all parties can benefit;
every page on every website can be one click away from being shared with friends and family via social media;
building a list of favorites which include the current promotions and notes from previous journeys is just so incredibly convenient that surfing the web any other way will stand out in stark contrast; and
having passwords to hand for each website visit means that consumers will be more secure because they will be less reliant on a few passwords they can memorise, instead they can be confident of creating new ones for every login they have.

A publisher user may replace any internet link located in any device, software, web page, application or system which they control, with such an enhanced link. Provided that the device, software, web page, application or system is connected to the internet then when the consumer user clicks the replacement enhanced link, the method will record the click and take the consumer to the relevant administrator website and then, through either a process of deliberate consumer use action (Clicking a continue button) or automatically, depending on the settings contained within the link and/or user parameters and/or settings, open the original target page in a Frame, Tab or Window or screen (depending on the device or technology or user settings).

The publisher can advantageously gain incremental revenue at little or no incremental cost, and the auto-enhance link code can automatically convert all external links including those not normally monetised, into potential revenue.

As a further illustration of the invention, placement of such code on a search engine's results page would dictate that all “natural/organic” search result links would become enhanced and therefore each time a natural/organic link was clicked the dynamic reference window would be created and the search provider would be monetising all of their natural/organic search listings as well as their paid-for search listings.

As a yet further illustration of the invention, placement of such code on a blog site would dictate that all external links in the articles would become enhanced and therefore each time a link was clicked the dynamic reference window would be created and the Blogger would be monetising all of their exit traffic.

As further illustration of the invention, placement of an enhanced link within the link path of a promotional email campaign, would dictate that the journey would become enhanced and deliver considerably more opportunities for the consumer to find the product or service that they are interested in.

According to an embodiment of the invention, a Merchant is able to add hidden code to their own website which will allow the merchant to add discount and/or vouchers promotion details for use by the consumer user, directly into the administration interface without delay or requirement to interact with the administration interface.

The merchant benefits from, for example, rapid deployment of targeted incentives to the consumer which help facilitate conversions and reduce the likelihood of the consumer going elsewhere.

As a result of the consumer having more information to hand the consumer is able to make quicker, more confident, decisions and purchases.

To conclude by way of specific further examples, the invention can provide for a greatly enhanced user experience. The user travelling for example from site A to Site B using an enhanced link according to the present invention can pull intelligence from where the they are coming from, i.e. the source location, where they are intending to go, where they have been in the past and where similar users have chosen to go along with other intelligence factors such as news, the current events and trends.

The functionality of the present invention serves to blend this intelligence dynamically in real-time, i.e. “on the fly” to generate a unique user specific reference-data window alongside or in a separate tab/window to the destination site B.

The reference-data window presents the user with a variety of tools to help them complete their intended transaction on site B or make an intelligent decision regarding moving on to further sites C, D, E, F etc.

In further detail, a consumer clicks a link taking them to visit a website of a leading department store having accessed that link in an article about nappy rash on a particular website having the “enhances links” feature enabled.

The method/system of the present invention can look at the page the user is travelling from, assess the keywords on the page look at the page they are travelling to—a page about baby clothes, gather up many other intelligence points and present the reference-data window. In the frame version the department store website will be presented in one area of the screen whilst a customised series of optional tools is presented in another area of the screen. These customised options could include any one or more of: voucher and discount codes for the department store; links or adverts or a list of competitor stores offering similar products; a range of products or services which may appeal to a parent with very young children; the ability to add notes about the department store website; and/or reviews about the products listed on the page.

The benefit to a user of travelling from A to B via an enhanced link of the present invention comprise, for example; improved web-experience, a far greater amount of information at one location, greater relevance of advertising, and information/offers relevant to the journey they are on, and further advertising, with intelligent offers/interests relevant to the journey they are on.

It will be appreciated that formation of a so-called “enhanced link” can provide an important feature of the invention and out lined below, merely for illustrative purposes, is an example of the “code-wrapping”.

An example of the enhanced url:

http://1.myclickpal.com/?PID=2024&SUB=test&CID=34&URL=http://www.bunches.co.uk
to reach the enhanced url the invention takes the target url:
http://www.bunches.co.uk
and pre-pends it to the invention url
http://1.myclickpal.com/?URL=http://www.bunches.co.uk
to this the url the Publisher ID (PID) is added. The PID is allocated to a publisher once they complete the registration process.
http://1.myclickpal.com/?PID=2024&URL=http://www.bunches.co.uk
should the publisher wish to add a sub ID/reference to track back any commissions to the source of the enhanced link, then they add SUB= to the url and then their sub id/reference:
http://1.myclickpal.com/?PID=2024&SUB=mywebpage&URL=http://www.bunches.co.uk

The publisher has the ability to specify which aspects of the invention they wish the user to experience. They do this using the CID=parameter and adding in a number that is supplied by the inventors. The CID customisation can also be used to add branding or logos to the admin panel or to display a message box to the user.

http://1.myclickpal.com/?PID=2024&SUB=mywebpage&CID=34&URL=http://www.bunches.co.uk

1. A website access method comprising the steps of:
receiving a user via a link from an internet accessible source to a target website to be accessed;
including within the said link a journey-identifier so as to provide for identification of the source and the target;
retrieving data from at least one of the source and the target website;
responsive to the retrieved data, creating reference data relevant to the target website; and
arranging for display of the reference data.

2. A method as claimed in claim 1, wherein the reference data is collected, collated dynamically in real-time simultaneously with the accessing of the target website so as to be ready for display at the same time, or even before, or shortly after display of the target website.

3. A method as claimed in claim 1, and arranged to be employed in relation to any form of Internet-enabled source displaying/presenting any one or more of a website, blog, article, email or text message.

4. A method as claimed in claim 1, wherein the journey-identifier identifies the source by way of a source domain and/or a Publisher user identifier.

5. A method as claimed in claim 4, wherein the journey-identifier identifies the target by way of target domain, Page identifier and/or Merchant user identifier.

6. A method as claimed in claim 5, wherein the journey-identifier employs a URL as a pointer to at least one of the source and target.

7. A method as claimed in claim 5, wherein the journey-identifier comprises code that is combined with, so as to enhance, the link to the target URL.

8. A method as claimed in claim 1, and including the step of identifying links within the source that point externally to the source's domain, and enhancing each such link with the journey-identifier.

9. A method as claimed in claim 7, wherein the journey-identifier is added in this manner as the Consumer user loads the source.

10. A method according to claim 1 wherein the retrieval of data from the source and/or target website is achieved through keyword indexing and weighting.

11. A method as claimed in claim 1, wherein the display of the reference data and the target website is provided in any appropriate format whether as a simultaneous frame structure, or by way of a selectable tab structure or browser interface.

12. A method as claimed in claim 1, wherein the reference data further comprises information such as related promotional offers, special deals, voucher/discount codes

13. A method as claimed in claim 1, wherein the reference data further comprises information such as people/contact profiles

14. A method as claimed in claim 1, wherein the reference data further comprises information such as competitors and similar sites

15. A method as claimed in claim 1, wherein the reference data further comprises information such as Price Comparison, Product Match & Classifieds Look-up

16. A method as claimed in claim 1, wherein the reference data further comprises information such as Trust, Reviews and Social Media Feedback

17. A method as claimed in claim 1, wherein the reference data further comprises information such as jobs and careers

18. A method as claimed in claim 1, wherein the reference data can include a history of previous websites visited plus user note keeping and marking of favourites.

19. A method as claimed in claim 1, wherein the reference data includes the past/current activity of other similar Consumer users.

20. A website access method comprising the steps of: selecting by way of a web browser function a target website by way of a URL to the target website;
incorporating a toolbar function into the browser wherein the toolbar function offers a selection of functionality relating to reference data associated with the target website;
retrieving reference data relevant to the target website; and
arranging for display of the reference data to a consumer user responsive to selection by way of the toolbar function.

21. A method as claimed claim 20, wherein the reference data is retrieved as the browser loads the target website.

22. A method as claimed claim 20, wherein the reference data is collected, collated dynamically in real-time simultaneously with the accessing of the target website so as to be ready for display at the same time, or even before, or shortly after display of the target website.

23. A method according to claim 20 wherein the retrieval of data from the target website is achieved through keyword indexing and weighting.

24. A method as claimed in claim 20, wherein the reference data further comprises information such as related promotional offers, special deals, voucher/discount codes

25. A method as claimed in claim 20, wherein the reference data further comprises information such as people/contact profiles

26. A method as claimed in claim 20, wherein the reference data further comprises information such as competitors and similar sites

27. A method as claimed in claim 20, wherein the reference data further comprises information such as Price Comparison, Product Match & Classifieds Look-up

28. A method as claimed in claim 20, wherein the reference data further comprises information such as Trust, Reviews and Social Media Feedback

29. A method as claimed in claim 20, wherein the reference data further comprises information such as jobs and careers

30. A method as claimed in claim 20, wherein the reference data can include a history of previous websites visited plus user note keeping and marking of favourites.

31. A method as claimed in claim 20, wherein the reference data includes the past/current activity of other similar Consumer users.

32. A method as claimed in claim 1, and including a step of switching the focus of the said reference data from the said target website to a further target website and in response to user input.

33. A method as claimed in claim 20, and including a step of switching the focus of the said reference data from the said target website to a further target website and in response to user input.

34. An internet navigation system comprising:
a receiver for receiving a link triggered from at an internet accessible source to a target website to be accessed;
an identifier for including within the said link a journey identifier so as to provide for identification of the source and the target website;
a data capture element for retrieving data from at least one of the source and the target website;
a reference data collator for creating reference data relevant to the target website and responsive to the retrieved data; and
a display for the display of the reference data.

35. A system as claimed in claim 34, wherein the data capture element and reference data collator are arranged to operate dynamically in real-time simultaneously with the accessing of the target website so as to be ready for display at the same time, or even before, display of the target website.

36. A system as claimed in claim 34, and arranged to be employed in relation to any form of Internet-enabled source displaying/presenting any one or more or more of a website, blog, article, email, application or text message.

37. A system as claimed in claim 34, wherein the journey-identifier is arranged to provide code that is combined with, so as to enhance, the said link.

38. A system as claimed in claim 34, and further be arranged to identify links within the source that point externally to the source's domain, and enhancing each such link with the journey-identifier.

39. A system as claimed in claim 34, and arranged to provide for the recordal and display of the target website for subsequent-user selection in a manner that, through use of the enhanced link, will also recall the navigation path from the source.

40. A system as claimed in claim 34 and including a controller for switching the focus of the said reference data from the said target website to a further target website, the controller being arranged to switch the said focus responsive to user input.

41. A dynamic publisher-user internet navigation tool arranged, in real-time, to identify an exit link at an internet accessible source, the exit link linking to a target website and the tool further arranged to add a journey-identifier to the exit link identifying a journey to the target website.

42. A tool as claimed in claim 41, and arranged to search for and enhance all potential exit links at an internet accessible source.

43. A tool as claimed in claim 42, wherein the journey identifier provides for identification of the source and target website.
